(19) United States
(12) Patent Application Publication
(10) Pub. No.: US 2013/0238403 A1
(43) Pub. Date: Sep. 12, 2013

(54) PERSONNEL MANAGEMENT SYSTEMS AND RELATED METHODS

(71) Applicant: Lee Benson, Phoenix, AZ (US)

(72) Inventor: Lee Benson, Phoenix, AZ (US)

(73) Assignee: EVALUATE TO WIN, LLC, Phoenix, AZ (US)

(21) Appl. No.: 13/413,107

(22) Filed: Mar. 6, 2012

(51) Int. Cl. G06Q 10/06

(52) U.S. Cl. 705/7.42

(57) ABSTRACT

Embodiments of personnel management systems are presented herein. Other examples, and related methods, are also disclosed herein.

### TECHNICAL FIELD

The present disclosure relates generally to computerized information systems, and relates, more particularly, to personnel management systems and related methods.

### BACKGROUND

Personnel evaluations have become an integral part of the efforts of companies or entities trying to manage their human resources and measure the contributions of their personnel for efficiency, compensation, and promotion purposes. Too often, however, such personnel evaluations focus on pure performance numbers with respect to performance-driven criteria for its personnel, without considering the contributions or effects of its personnel with respect to desired business culture criteria or goals. Current personnel evaluation tools also fail to consider the interaction between such performance criteria and business culture criteria for the personnel being evaluated, and fail to provide a metric and/or a graphical representation of such interaction.

Considering the above, further developments can be made to positively impact personnel management systems and related methods.

### BRIEF DESCRIPTION OF THE DRAWINGS

The present disclosure will be better understood from a reading of the following detailed description of examples of embodiments, taken in conjunction with the accompanying figures in the drawings.

FIG. 1 illustrates a block diagram of a personnel evaluation system according to one embodiment of the current disclosure.

FIG. 2 illustrates a flow chart of method 2000 for implementing evaluation system 1000 of FIG. 1.

FIG. 3 illustrates an evaluation interface of the personnel evaluation system.

FIG. 4 illustrates an evaluee evaluation report of the personnel evaluation system.

FIG. 5 illustrates a team evaluation report of the personnel evaluation system.

FIG. 6 illustrates a team relative scoring report of the personnel evaluation system for a team of personnel.

FIG. 7 illustrates a team average criteria scoring report of the personnel evaluation system for the team of personnel.

FIG. 8 illustrates a recompense report of the personnel evaluation system for the team of personnel.

FIG. 9 illustrates a computer that is suitable for implementing an embodiment of at least a portion of the personnel evaluation system.

FIG. 10 illustrates a representative block diagram of elements forming part of the computer of FIG. 9.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types. The absence of the word “removably,” “removable,” and the like near the word “coupled,” and the like does not mean that the coupling, etc. in question is or is not removable.

### DETAILED DESCRIPTION

In one embodiment, a personnel management system for evaluating one or more evaluees can comprise an evaluation analyzer module and a display module. The evaluation analyzer module can be executable by one or more data processor devices and configured to (a) receive personnel culture alignment data comprising one or more first evaluee culture scores of a first evaluee, correlated to one or more business culture criteria for the first evaluee, and (b) receive personnel performance data comprising one or more first evaluee performance scores of the first evaluee, correlated to one or more performance criteria for the first evaluee. The evaluation analyzer module can also calculate a first evaluee proficiency score of the first evaluee based on the one or more first evaluee culture scores of the first evaluee and on the one or more first evaluee performance scores of the first evaluee. The display module can be configured to display one or more personnel evaluation reports.

In one embodiment, a method for evaluating one or more evaluees can comprise providing an evaluation analyzer module and providing a display module. The evaluation analyzer module can be configured to (a) receive personnel culture alignment data comprising one or more first evaluee culture scores of a first evaluee, correlated to one or more business culture criteria for the first evaluee, and (b) receive personnel performance data comprising one or more first evaluee performance scores of the first evaluee, correlated to one or more performance criteria for the first evaluee. The evaluation analyzer module can also calculate a first evaluee proficiency score of the first evaluee based on the one or more first evaluee culture scores of the first evaluee, and on the one or more first evaluee performance scores of the first evaluee. The display module can be configured to display one or more personnel evaluation reports. At least the evaluation analyzer module can be executable by one or more data processor devices.

In one embodiment, an evaluation interface module can be operable on one or more processors, storable in one or more memory units, displayable at a client computer, and/or configured to couple to a personnel management system comprising an evaluation analyzer module. The evaluation interface module can comprise an evaluation interface panel and a first evaluee evaluation report panel. The evaluation interface panel can be configured to (a) receive personnel culture alignment data comprising one or more first evaluee culture scores of a first evaluee, correlated to one or more business culture criteria for the first evaluee, and (b) receive personnel performance data comprising one or more first evaluee performance scores of the first evaluee, correlated to one or more performance criteria for the first evaluee. The first evaluee evaluation report panel can be configured to present a first evaluee proficiency score of the first evaluee, where the first evaluee proficiency score can be received from the personnel management system and calculated by the evaluation analyzer module based on the one or more first evaluee culture scores and the one or more first evaluee performance scores. The display module can also be configured to present an evaluation grid comprising a performance score axis a culture score axis perpendicular to the performance score axis, and a first evaluee proficiency marker representative of the first evaluee proficiency score relative to the performance score axis and the culture score axis.

Other examples and embodiments are further disclosed herein. Such examples and embodiments may be found in the figures, in the claims, and/or in the present description.

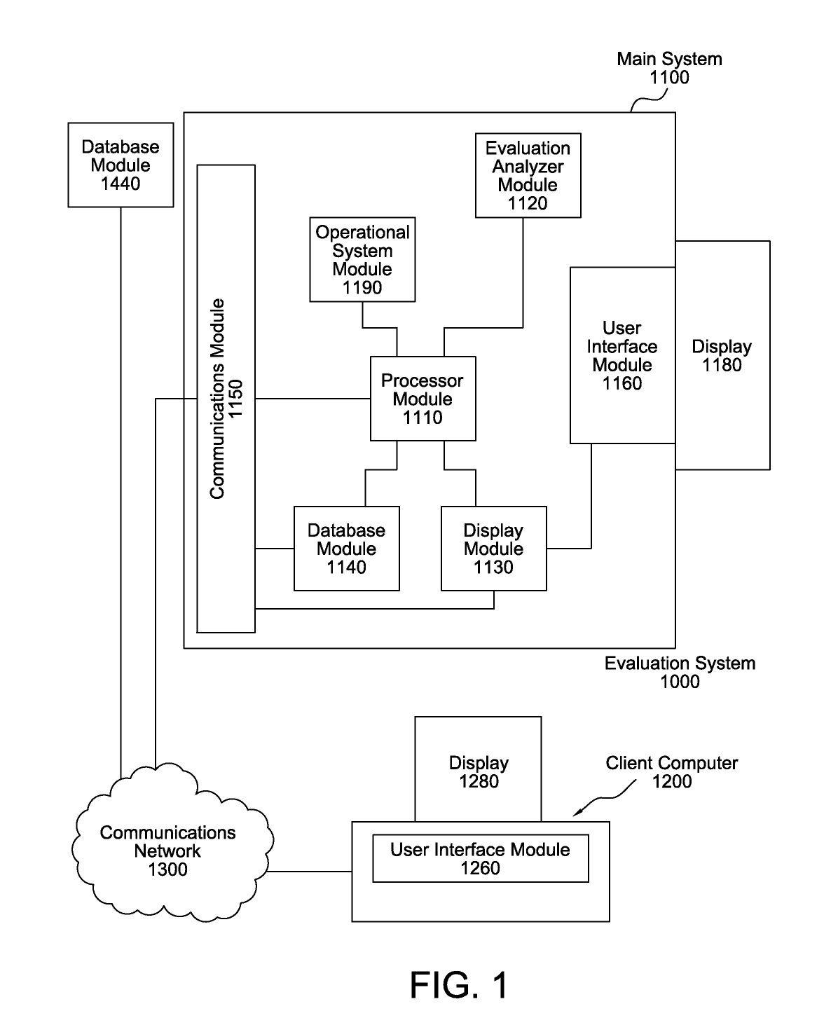

Turning to the drawings, FIG. 1 illustrates block diagram of evaluation system 1000, according to a first embodiment for managing evaluations of personnel, such as employees or contractors of a business. Evaluation system 1000 is merely exemplary and is not limited to the embodiments presented herein. Evaluation system 1000 can be employed in many different embodiments or examples not specifically depicted or described herein.

In the present example, evaluation system 1000 comprises main system 1100 configured to communicate with client computer 1200 via communications network 1300. In some examples, communications network 1300 can be a combination of wired and/or wireless networks. For example, communications network 1300 can include the Internet, wireless or wired computer networks, cellular telephone networks (e.g. a 4G (fourth generation) cellular network), and the like. In the same or other examples, evaluation system 1000 may rely on cloud computing between main system 1100 and client computer 1200 through communications network 1300. In such examples, most computing and/or data storage operations can be performed at or by main system 1100, and/or client computer 1200 can act primarily to implement a user interface to input or access information to or from main system 1100. Client computer 1200 can implement the user interface via user interface module 1260, which can comprise a webpage and/or a graphical user interface (GUI) presented on display 1280 of client computer 1200.

Main system 1100 comprises processor module 1110, operating system module 1190, evaluation analyzer module 1120, display module 1130, database module 1140, and communications module 1150. Main system 1100 can also comprise user interface module 1160 and display 1180 as shown in FIG. 1, which can be similar to user interface module 1260 and display 1280 of client computer 1200, but are configured instead for local input or access to or from main system 1100 without relying on communications network 1300. In examples where main system 1100 comprises user interface module 1160 and display 1180, client computer 1200 may be optional, and vice-versa.

Evaluation system 1000 can also comprise database module 1440, which can be located remote of main system 1100, and/or can be accessible thereto via communications network 1300. Database module 1440 can be similar to database module 1140, and where evaluation system 1000 comprises one of them, the other one can be optional.

In some embodiments, “main system,” as used herein, can refer to a single computer, single server, or a cluster or collection of servers. Typically, a cluster or collection of servers can be used when the demands by client computers, such as client computer 1200, are beyond the reasonable capability of a single server or computer. In many embodiments, the servers in the cluster or collection of servers are interchangeable from the perspective of the client computers.

In some examples, a single server can include processor module 1110, evaluation analyzer module 1120, display module 1130, database module 1140, communications module 1150, and/or operating system module 1190. In other examples, a first server can include a first portion of these modules. One or more second servers can include a second, possibly overlapping, portion of these modules. In these examples, main system 1100 can comprise the combination of the first server and the one or more second servers.

In some examples, database module 1140 (and/or database module 1440) can include one or more indexes to store information about one or more personnel evaluations. All of these indexes can be a structured collection of records or data, for instance, which is stored in database module 1140. For example, the indexes stored in database module 1140 can be an XML (Extensible Markup Language) database, MySQL, or an Oracle® database. In the same or different embodiments, the indexes could consist of a searchable group of individual data files stored in storage component 1140.

In various embodiments, operating system module 1190 can be a software program that manages the hardware and software resources of a computer and/or a computer network. Operating system module 1190 performs basic tasks such as, for example, controlling and allocating memory, prioritizing the processing of instructions, controlling input and output devices, facilitating networking, and managing files. Examples of common operating systems for a computer include Microsoft® Windows, Mac® operating system (OS), UNIX® OS, and Linux® OS. Common operating systems for a mobile device include the iPhone® operating system by Apple Inc. of Cupertino, Calif., the Blackberry® operating system by Research In Motion (RIM) of Waterloo, Ontario, Canada, the Palm® operating system by Palm, Inc. of Sunnyvale, Calif., the Android operating system developed by the Open Handset Alliance, the Windows Mobile operating system by Microsoft Corp. of Redmond, Wash., or a Symbian operating system by Nokia Corp. of Espoo, Finland.

As used herein, “processor” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions.

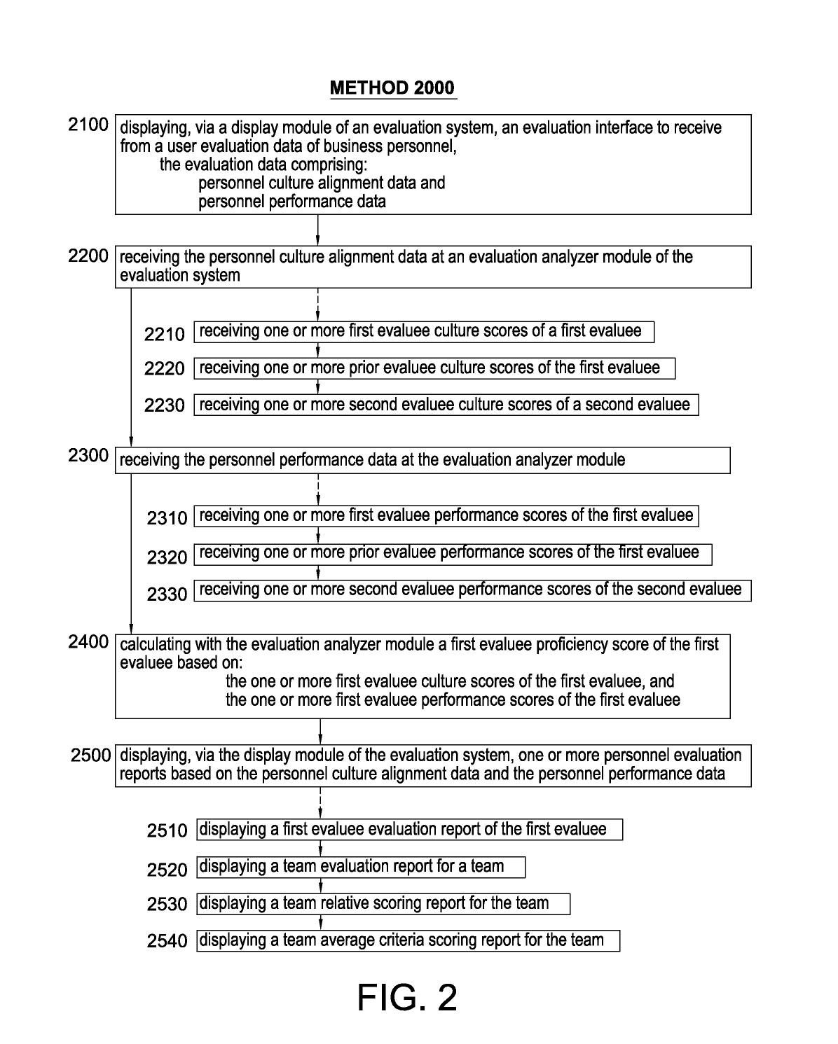

FIG. 2 illustrates a flow chart of method 2000 for implementing evaluation system 1000 of FIG. 1. Method 2000 is merely exemplary and is not limited to the embodiments presented herein. Method 2000 can be employed in many different embodiments or examples not specifically depicted or described herein. In some embodiments, the activities, the procedures, and/or the processes of method 2000 can be performed in the order presented. In other embodiments, the activities, the procedures, and/or the processes of method 2000 can be performed in any other suitable order. In still other embodiments, one or more of the activities, the procedures, and/or the processes in method 2000 can be combined or skipped.

Block 2100 of method 2000 comprises displaying, via a display module of the evaluation system, an evaluation interface to receive from a user evaluation data of business personnel. In the present example, the evaluation data can comprise personnel culture alignment data and personnel performance data. In some examples, the evaluation system can be similar to evaluation system 1000 (FIG. 1), and/or the display module can be similar to display module 1130 of main system 1100 (FIG. 1). In the same or other examples, the display module can comprise a display itself, and can be configured to present one or more user interfaces of the evaluation system, such as the evaluation interface. In other examples, such as shown in FIG. 1, the display module can display the one or more user interfaces, such as the evaluation interface, via a user interface module coupled to a display, such as user interface module 1160 coupled to display 1180 at main system 1100, and/or such as user interface module 1260 coupled to display 1280 at client computer 1200 (FIG. 1).

Method 2000 comprises block 2200 for receiving the personnel culture alignment data of block 2100 at an evaluation analyzer module of the evaluation system. In some examples, the personnel culture alignment data may correspond to expectations for personnel with respect to one or more cultural requirements of the organization for whom the personnel works. Such cultural requirements may also be called alignment requirements or alignment tools, because they enable the organization to align their teams and team members culturally with respect to a mission/vision statement, behaviors/values traits, and/or leadership traits. Organizations develop their cultural requirements, often with professional consultants, to identify the mission/vision of their organization as well as the behavioral values and leadership traits that should guide their personnel to accomplish the organization's mission/vision. It can be said that a mission/vision is the “what” of an organization does, and the behavioral values are the “how” the organization does it. In some examples, one or more of the cultural requirements may be the same for all personnel of the organization. For example, the mission/vision statement requirement may be the same for all, while leadership trait requirements can vary depending on an individual's position. There can be examples, however, where all cultural requirements may be tailored to be applicable to all personnel of the organization.

There can be examples where cultural requirements can be considered as “soft” requirements, because they may have no quantitative metrics and can be evaluated subjectively. In some examples, a “soft” scoring criteria can be devised to enable an objective evaluation regardless of any non-quantitative or subjective nature of cultural requirements. In the same or other examples, a “soft” scoring criteria similar to the following may be presented to an evaluee to grade the evaluee with respect to a cultural requirement or alignment tool:
“If you don't remember this Alignment Tool you can't score more than −0-. Remember it, but not word for word, you can add −2-points. Remember it word for word, you can add −4-points. Have 3 examples where you have used this Alignment Tool as it relates to your job to make the company more successful, you can add −2-points each. You must put these examples in the notes for this Alignment Tool found in your “Requirements For My Next Evaluation” before your actual evaluation date. Remember this Alignment Tool word for word and have 3 clear examples of where you used this Tool as it relates to your job to make the company more successful, you are a −10-! If your manager has examples where you didn't use this Alignment Tool as it relates to your job, he or she can subjectively take points away.”

In some examples, the evaluation analyzer module of block 2200 can be similar to evaluation analyzer module 1120 of main system 1100 (FIG. 1). Block 2200 can comprise sub-block 2210 for receiving, as part of the personnel culture alignment data, one or more first evaluee culture scores of a first evaluee. Other sub-blocks of block 2200 are described later.

Method 2000 also comprises block 2300 for receiving the personnel performance data of block 2100 at the evaluation analyzer module of the evaluation system. In some examples, the personnel performance data may correspond to expectations for personnel with respect to one or more performance requirements of the organization for whom the personnel works. The performance requirements can be cascaded down from an organization's strategy, objectives and/or annual operating plan, and can denote specific requirements for which a team and/or team member will be accountable. Performance requirements describe specific performance items or activities like sales, costs, delivery, etc. for which a specific team or a specific team member can being held accountable, and are, therefore, subject to a performance evaluation. Performance requirements can be considered as “hard” requirements from a scoring criteria perspective, because they can have quantitative metrics that are objectively measurable.

In some examples, Block 2300 of method 2000 can comprise sub-block 2310 for receiving, as part of the personnel performance data, one or more first evaluee performance scores of the first evaluee. Other sub-blocks of block 2300 are described later.

The personnel culture alignment data of block 2200 and the personnel performance data of block 2300 may be received by evaluation system 1000 from the user via user interface module 1260 and/or user interface module 1160 (FIG. 1) in some examples, and then routed to evaluation analyzer module 1120 for evaluation and/or to one or more of database modules 1140 or 1440 for storage. In the same or other examples, as seen in FIG. 1, communications module 1150 can be coupled to database module 1140 and/or database module 1440 to send the personnel culture alignment data of block 2200 and/or the personnel performance data of block 2300 thereto for storage, and/or to send to the evaluation analyzer module the personnel culture alignment data of block 2200 and/or the personnel performance data of block 2300 from database module 1140 and/or database module 1440.

In the same or other examples, communications module 1150 can be configured to couple to user interface module 1260 of client computer 1200 via communications network 1300. User interface module 1260 is configured to receive the personnel culture alignment data of block 2200 and the personnel performance data of block 2300 input thereto by a user, and to send the personnel culture alignment data of block 2200 and the personnel performance data of block 2300 to communications module 1150 via communications network 1300. As indicated previously, communications network 1300 can comprise a cloud computer network or be configured to support cloud computing for evaluation system 1000 in some embodiments.

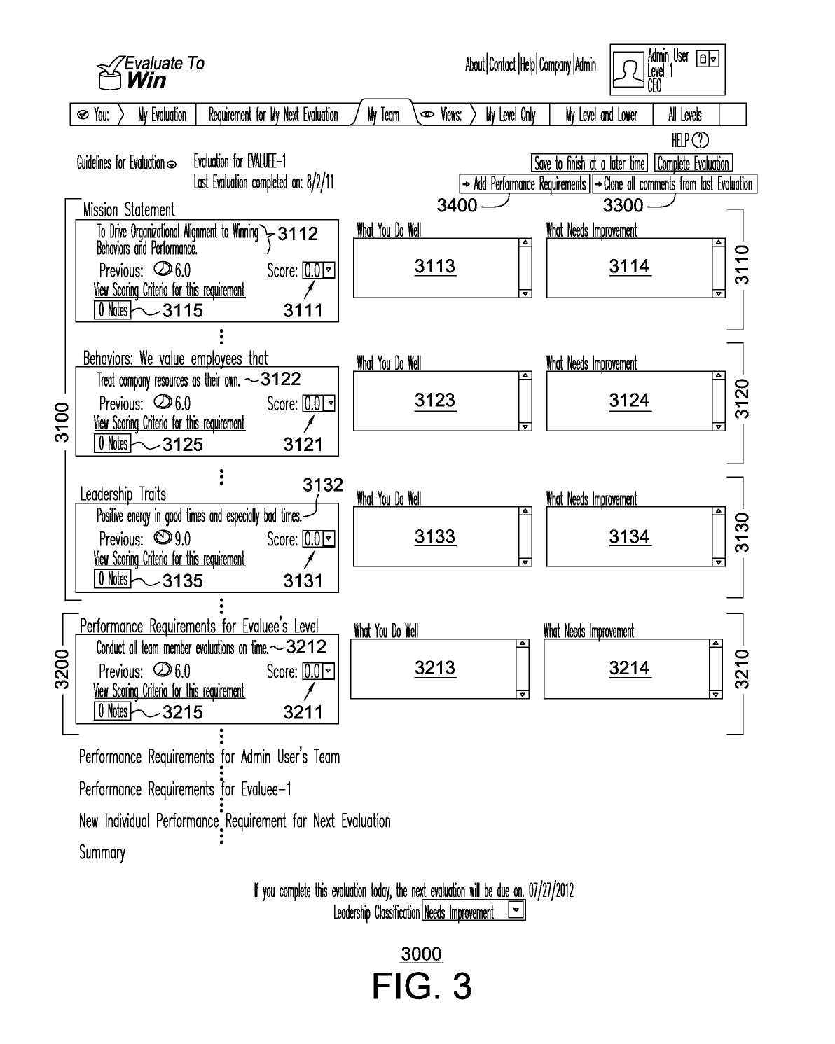

FIG. 3 illustrates evaluation interface 3000, which can be similar to the evaluation interface of block 2100 of method 2000 in FIG. 2. In some examples, evaluation interface 3000 can be presented as an evaluation interface panel by user interface module 1260 and/or user interface module 1160 (FIG. 1). In the present example, evaluation interface 3000 can be used by an evaluator for an evaluation of an evaluee. In some examples, the evaluator can be the manager or supervisor of the evaluee.

Evaluation interface 3000 comprises culture score interface 3100 configured to receive from the evaluator a score for each of one or more evaluee culture scores of the evaluee. In the present example, culture score interface 3100 comprises: (a) mission statement score interface 3110 configured to receive from the evaluator mission statement score 3111 reflective of an assessment of the evaluee with respect to business mission statement criteria 3112, (b) behavior score interface 3120 configured to receive from the evaluator behavior score 3121 reflective of an assessment of the evaluee with respect to business values criteria 3122, and (c) leadership score interface 3130 configured to receive from the evaluator leadership score 3131 reflective of an assessment of the evaluee with respect to leadership criteria 3132. Accordingly, the one or more evaluee culture scores of the evaluee can comprise mission statement score 3111, behavior score 3121, and/or leadership score 3131 in FIG. 3.

Evaluation interface 3000 also comprises performance score interface 3200 configured to receive from the evaluator a score for each of one or more evaluee performance scores of the evaluee. In the present example, performance score interface 3200 comprises performance score interface 3210 configured to receive from the evaluator performance score 3211 reflective of an assessment of the evaluee with respect to performance criteria 3212. It should be noted that, due to space constraints, FIG. 3 presents only one evaluation criteria and score interface for each of culture score interface 3100, behavior score interface 3120, leadership score interface 3130, and performance score interface 3210. Nevertheless, each of such interfaces can comprise one or more evaluation criteria and score interfaces, as denoted by the “ . . . ” symbols.

In some implementations, the culture criteria from culture score interface 3100 (such as business mission statement criteria 3112, business values criteria 3122 or leadership criteria 3132) and/or the performance criteria from performance score interface 3200 (such as performance criteria 3212) may be generated or designed to suit to the evaluation system client of evaluation system 1000. For example, the evaluation system client may be a person or company having specific goals that it wishes to advance with respect to its business culture and/or personnel performance. In some examples, the evaluation system client may be the owner of client computer 1200 and/or may be provided with access to user interface module 1260 by the evaluation system provider of evaluation system 1000 (FIG. 1). In the same or other examples, at least some of the culture criteria and/or the performance criteria for evaluation interface 3000 may be generated or recommended by the evaluation system provider upon consultation from the evaluation system client to suit the needs or goals of the evaluation system client.

In the present example of FIG. 3, evaluation interface 3000 also comprises comment sections for each of mission statement score interface 3110 (with comment sections 3113 and 3114), behavior score interface 3120 (with comment sections 3123 and 3124), leadership score interface 3130 (with comment sections 3133 and 3134), and performance score interface 3210 (with comment sections 3213 and 3214). In the present example, the comment sections are split between positive comment sections (3113, 3123, 3133, and 3213) and improvement comment sections (3114, 3124, 3134, and 3214), although there can be other embodiments with other and/or additional types of comment sections.

Evaluation interface 3000 also comprises importation interface 3300 configured to import one or more prior scores or prior comments from a prior evaluation of the evaluee. As an example, when importation interface 3300 is actuated by the evaluator, the one or more prior scores and/or the one or more prior comments can be retrieved from database module 1140 (FIG. 1) and/or database module 1440 (FIG. 1) and imported into evaluation interface 3000.

Evaluation interface 3000 further comprises one or more evaluee notes interfaces, such as evaluee notes interfaces 3115, 3125, 3135, and 3215, configured to access and present one or more notes previously entered into evaluation system 1000 by the evaluee regarding the evaluee's own proficiency with respect to at least a portion of one or more business culture criteria (such as business mission statement criteria 3112, business values criteria 3122 or leadership criteria 3132), or with respect to a portion of one or more performance criteria (such as performance criteria 3212). In some examples, the one or more notes previously entered by the evaluee may be retrieved from database module 1140 (FIG. 1) and/or database module 1440 (FIG. 1). The evaluee's notes can be beneficial to the evaluator when determining the one or more evaluee culture scores or the one or more evaluee performance scores of the evaluee.

In the present example, evaluation interface 3000 also comprises evaluation criteria modification interface 3400 configured to add to evaluation interface 3000 a new business culture criteria to the one or more business culture criteria in culture score interface 3100, and/or to add to evaluation interface 3000 a new performance criteria to the one or more performance criteria in performance score interface 3200. In some examples, the new business culture criteria and/or the new performance criteria can be added for the current evaluation, or for subsequent evaluations.

Backtracking to FIG. 2, block 2400 of method 2000 comprises calculating, with the evaluation analyzer module, a first evaluee proficiency score of the first evaluee based on the one or more first evaluee culture scores of the first evaluee, and the one or more first evaluee performance scores of the first evaluee. Block 2500 of method 2000 comprises displaying, via the display module of the evaluation system, one or more personnel evaluation reports based on the personnel culture alignment data and the personnel performance data received by the evaluation analyzer in blocks 2200 and 2300.

In the present example of FIG. 1, user interface module 1260 of client computer 1200 can be configured to send the personnel culture alignment data of block 2200 and the personnel performance data of block 2300 received from the user to communications module 1150 of main system 1100 via communications network 1300. In addition, user interface module 1260 can be configured to receive, from main system 1100, the one or more personnel evaluation reports of block 2500 of method 2000 (FIG. 2) displayed by display module 1130 (FIG. 1) for presentation to one or more users at display 1280 of client computer 1200. In the same or other examples, user interface module 1160 may be configured similarly to user interface module 1260, but may receive the one or more personnel evaluation reports of block 2500 of method 2000 (FIG. 2) from within main system 1100 for presentation at display 1180 without having to rely on communications network 1300.

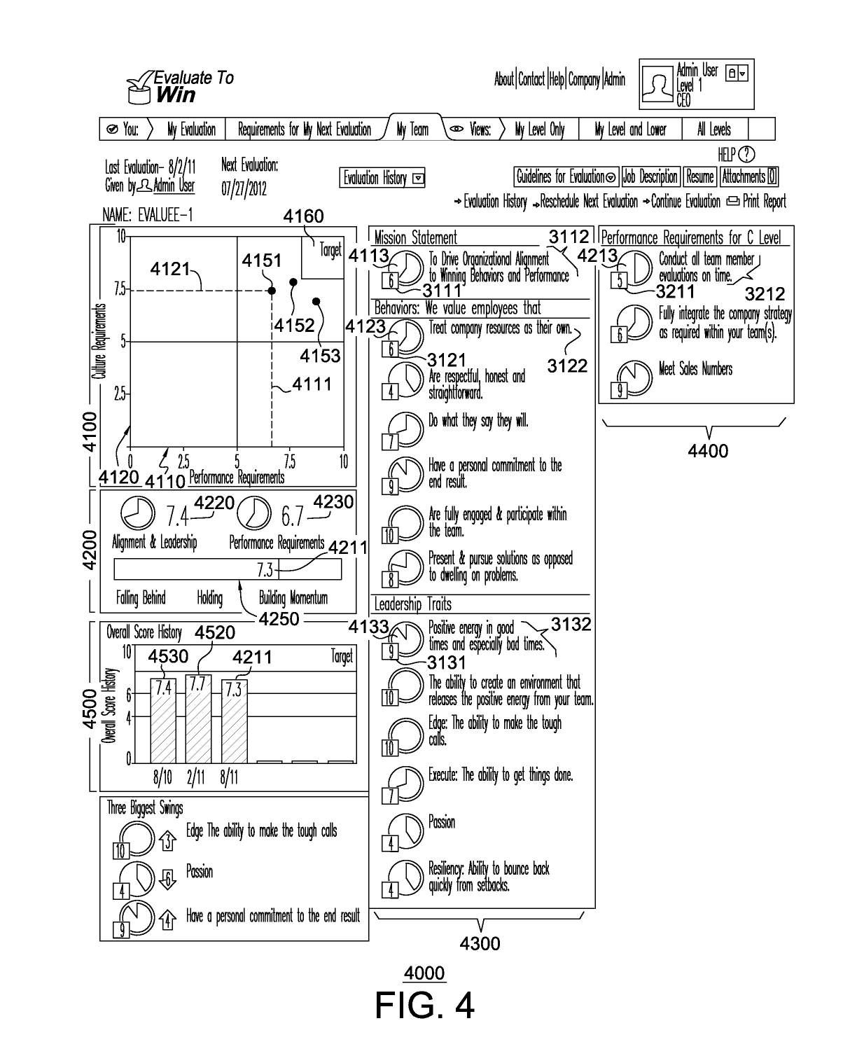

Block 2500 comprises sub-block 2510 for displaying a first evaluee evaluation report of the first evaluee. FIG. 4 illustrates evaluee evaluation report 4000, which can be similar to the first evaluee evaluation report of the first evaluee displayed by the display module in sub-block 2510 of block 2500 in method 2000 (FIG. 2). In some examples, evaluee evaluation report 4000 can correspond to the evaluation and scores gathered for the evaluee via evaluation interface 3000 (FIG. 3). In the same or other examples, evaluee evaluation report 4000 can be presented as an evaluee evaluation report panel by user interface module 1260 (FIG. 1) and/or user interface module 1160 (FIG. 1).

In the present example, evaluee evaluation report 4000 presents evaluee score section 4200 comprising evaluee proficiency score 4211, which can correspond to the first evaluee proficiency score calculated by the evaluation analyzer module in block 2400 of method 2000 (FIG. 2) based on the evaluation data input via evaluation interface 3000 (FIG. 3). In some examples, each of the one or more first evaluee culture scores of the first evaluee (such as mission statement score 3111, behavior score 3121, and leadership score 3131 from FIG. 3) and each of the one or more first evaluee performance scores of the first evaluee (such as performance score 3211 from FIG. 3) may be averaged together by evaluation analyzer module 1120 (FIG. 1) to calculate evaluee proficiency score 4211. In the same or other examples, when calculating the first evaluee proficiency score, evaluation analyzer module 1120 can be configured to consider different evaluative weights assigned to at least a portion of the one or more first evaluee culture scores of the first evaluee and/or assigned to at least a portion of the one or more first evaluee performance scores of the first evaluee.

Evaluation report 4000 also comprises evaluation grid 4100, with performance score axis 4110 and culture score axis 4120 perpendicular to performance score axis 4110. In the present example, performance score axis 4110 represents, a range of performance scores that an evaluee may attain based on the one or more culture scores received during his/her evaluation, as calculated by evaluation analyzer module 1120 (FIG. 1) in block 2400 of method 2000 (FIG. 2). Similarly, culture score axis 4120 represents a range of culture scores that the evaluee may attain based on the one or more evaluee performance scores received during his/her evaluation, as calculated by evaluation analyzer module 1120 (FIG. 1) in block 2400 of method 2000 (FIG. 2). In the present example, display module 1130 (FIG. 1) is configured to calculate and/or display evaluee proficiency marker 4151 at evaluation grid 4100, where evaluee proficiency marker 4151 is representative of evaluee proficiency score 4211 with respect to performance score axis 4110 and culture score axis 4120.

Evaluee evaluation report 4000 comprises culture scores section 4300 presenting the one or more first evaluee culture scores of the first evaluee received by evaluation analyzer 1120 (FIG. 2) at block 2210 of method 2000 (FIG. 2). For example, culture scores section 4300 presents scores and evaluation criteria initially entered into evaluation system 1000 (FIG. 1) via evaluation interface 3000 (FIG. 3) during the evaluee's evaluation, such as mission statement score 3111 for business mission statement criteria 3112, behavior score 3121 for business values criteria 3122, and leadership score 3131 for leadership criteria 3132.

Similarly, evaluee evaluation report 4000 comprises performance scores section 4400 presenting the one or more first evaluee performance scores of the first evaluee received by evaluation analyzer 1120 (FIG. 2) at block 2310 of method 2000 (FIG. 2). For example, performance scores section 4400 presents scores and evaluation criteria initially entered into evaluation system 1000 (FIG. 1) via evaluation interface 3000 (FIG. 3) during the evaluee's evaluation, such as performance score 3211 for performance criteria 3212.

As can be seen in evaluation report 4000, culture scores section 4300 and performance scores section 4400 present culture status icons and performance status icons, respectively, for the scores and criteria therein. For example, culture scores section 4300 comprises culture status icon 4113 (correlated to mission statement score 3111 and mission statement criteria 3112), culture status icon 4123 (correlated to behavior score 3121 and business values criteria 3122), culture status icon 4133 (correlated to leadership score 3131 and leadership criteria 3132), and performance status icon 4213 (correlated to performance score 3211 and performance criteria 3212). In the present example, the culture status icons and performance status icons comprise pie chart icons indicating of a score percentage for their correlated culture scores or performance scores. In the same or other examples, the culture status icons and performance status icons can comprise color-coded icons, such as icons with variable red, yellow, and green hues, that vary based on the score percentage of the icon's correlated culture score or performance score.

In the present example, evaluation analyzer module 1120 (FIG. 1) is configured to calculate evaluee combined culture score 4220, as displayed by display module 1130 (FIG. 1) in evaluee score section 4200 of evaluation report 4000. Evaluee combined culture score 4220 can be based on the one or more first evaluee culture scores of the first evaluee received by evaluation analyzer 1120 (FIG. 2) at block 2210 of method 2000 (FIG. 2), such as those shown in culture scores section 4300 of evaluation report 4000. In the present example, evaluee combined culture score 4220 corresponds to an average of the culture scores shown in culture scores section 4300, but there can also be embodiments where evaluation analyzer module 1120 (FIG. 1) can be configured to consider different evaluative weights for one or more of the culture scores in culture scores section 4300 when calculating evaluee combined culture score 4220.

Evaluation analyzer module 1120 (FIG. 1) is configured also to calculate evaluee combined performance score 4230, as displayed by display module 1130 (FIG. 1) in evaluee score section 4200 of evaluation report 4000. Evaluee combined performance score 4230 can be based on the one or more first evaluee performance scores of the first evaluee received by evaluation analyzer 1120 (FIG. 2) at block 2310 of method 2000 (FIG. 2), such as those shown in performance scores section 4400 of evaluation report 4000. In the present example, evaluee combined performance score 4230 corresponds to an average of the culture scores shown in culture scores section 4400, but there can also be embodiments where evaluation analyzer module 1120 (FIG. 1) can be configured to consider different evaluative weights for one or more of the performance scores in performance scores section 4400 when calculating evaluee combined culture score 4230.

Focusing on evaluation grid 4100, performance score axis 4110 presents a performance score range configured to comprise evaluee combined culture score 4230 for the evaluee. Similarly, culture score axis 4120 presents a culture score range configured to comprise evaluee combined culture score 4220. Display module 1130 (FIG. 1) is configured to calculate the location for evaluee proficiency marker 4151 at an intersection between performance intersect line 4111 and culture intersect line 4121, where performance intersect line 4111 is perpendicularly intersected to performance score axis 4110 at the value for evaluee combined performance score 4230, and where culture intersect line is perpendicularly intersected to culture score axis 4100 at the value for evaluee combined culture score 4220. Performance intersect line 4111 and culture intersect line 4121 are shown in FIG. 4 for illustrative purposes only to illustrate how the location of evaluee proficiency marker 4151 is calculated, and there can be embodiments where performance intersect line 4111 and culture intersect line 4121 need not be shown as part of evaluation grid 4100.

In the present embodiment, display module 1130 (FIG. 1) is also configured to display target zone 4160 in evaluation grid 4100 at evaluation report 4000, where target zone 4160 is representative of both a predetermined threshold culture score that the evaluee should strive for his/her evaluee combined culture score 4220, and a predetermined threshold performance score that the evaluee should strive for his/her evaluee combined performance score 4230. Target zone 4160 can be highlighted, comprising a different color and a delineated border with respect to other areas of evaluation grid 4100. Display module 1130 is configured to calculate the location of evaluee proficiency marker 4151 to be within target zone 4160 when both (a) evaluee combined culture score 4220 equals or exceeds the predetermined threshold culture score, and (b) evaluee combined performance score 4230 equals or exceeds the predetermined threshold performance score.

Evaluation report 4000 also comprises in the present example an evaluee proficiency momentum indicator 4250 configured to correlate evaluee proficiency score 4211 to a proficiency momentum classification, such as a decreasing proficiency classification, a stable proficiency classification, or an increasing proficiency classification. In some examples, such momentum correlation may be carried out by evaluation analyzer module 1120 or by display module 1130 (FIG. 1). There can be examples where the momentum correlation of evaluee proficiency score 4211 to the proficiency momentum classification can be based on a ratio between evaluee proficiency score 4211 and a maximum proficiency momentum score. In the same or other examples, the momentum correlation can consider or be based on a comparison between evaluee proficiency score 4211 and a prior evaluee proficiency score from a prior evaluation of the evaluee.

Evaluation system 1000 (FIG. 1) can also be configured to present a comparison of the evaluee's proficiency with respect to prior evaluations. For example, evaluation analyzer module 1120 (FIG. 1) can be configured to receive, in sub-block 2220 of block 2200 of method 2000 (FIG. 2), one or more prior evaluee culture scores from a prior evaluation of the evaluee. Similarly, evaluation analyzer module 1130 (FIG. 1) can be configured to receive, in sub-block 2320 of block 2300 of method 2000 (FIG. 2), one or more prior evaluee performance scores from a prior evaluation of the evaluee. In some examples, evaluation analyzer module 1120 can receive the one or more prior evaluee culture scores and/or the prior evaluee performance scores from either of database modules 1140 or 1440 (FIG. 1). Evaluation analyzer module 1120 can thus calculate prior evaluee proficiency score 4520 (FIG. 4) for the prior evaluation of the evaluee based on the one or more prior evaluee culture scores and the prior evaluee performance scores in a calculation similar to that described above with respect to block 2400 of method 2000 (FIG. 2) for the first evaluee proficiency score and/or for evaluee proficiency score 4211 (FIG. 4).

Once prior evaluee proficiency score 4520 is calculated by evaluation analyzer module 1120 (FIG. 1), display module 1130 can display it in evaluation report 4000 (FIG. 4) if desired. For example, evaluation report 4000 comprises historical score section 4500 where historical proficiency scores of the evaluee, including evaluee proficiency score 4211, prior evaluee proficiency score 4520 and prior evaluee proficiency score 4530 are presented relative to each other. In addition, display module 1130 can concurrently display in the present example one or more of prior evaluee proficiency markers 4152-4153, similar to evaluee proficiency marker 4151, but representative of prior evaluee proficiency score 4520 and 4530, in evaluation grid 4100.

Returning to FIG. 2, method 2000 can also comprise, as sub-block 2520 of block 2500, displaying a team evaluation report for a team comprising the first evaluee described above with respect to FIGS. 3-4 and a second evaluee. In such examples, block 2200 of method 2000 (FIG. 2) can comprise sub-block 2230 for receiving at the evaluation analyzer one or more second evaluee culture scores of an evaluation of the second evaluee, and block 2300 of method 2000 (FIG. 2) can comprise sub-block 2330 for receiving at the evaluation analyzer one or more second evaluee performance scores of an evaluation of the second evaluee.

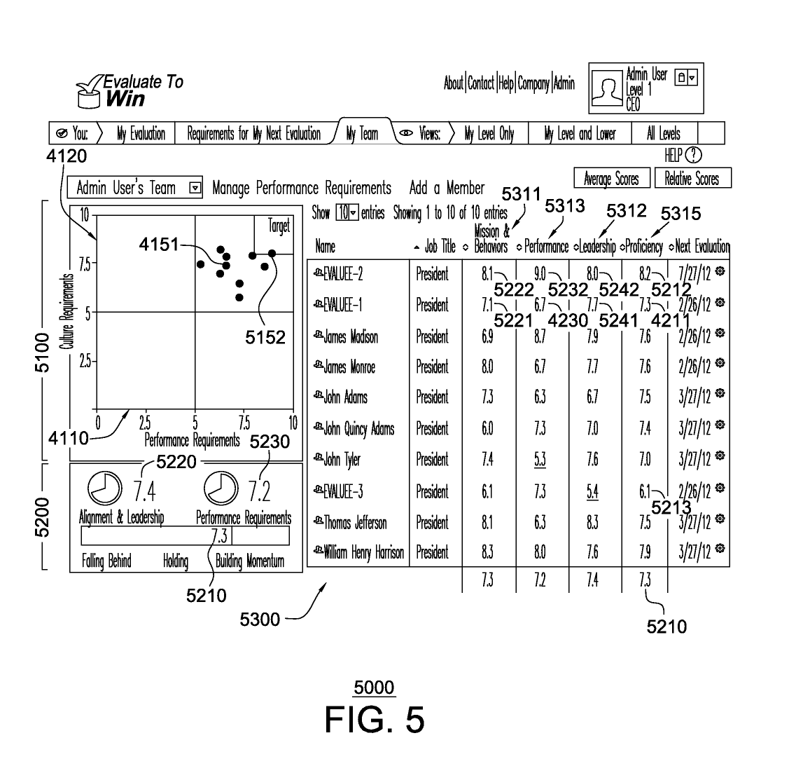

FIG. 5 illustrates team evaluation report 5000, which can be similar to the team evaluation report of sub-block 2520 of method 2000 (FIG. 2).

In some examples, team evaluation report 5000 can be presented as a team evaluation report panel by user interface module 1260 and/or user interface module 1160 (FIG. 1). In the present example, team evaluation report 5000 presents aggregated evaluation data from evaluations of team members of a user's team. For example, team evaluation report 5000 comprises evaluation grid 5100, which can be similar to evaluation grid 4100 (FIG. 4), but presents information with respect to the user's team rather than just information about a single evaluee.

In the present example, evaluation analyzer 1120 (FIG. 1) can calculate first evaluee proficiency score 4211 (FIGS. 4-5) as described above with respect to FIGS. 3-4, and can calculate second evaluee proficiency score 5212 (FIG. 5) in similar fashion based on the one or more second evaluee culture scores and the second evaluee performance scores received at sub-blocks 2230 and 2330 of method 2000 (FIG. 2). Display module 1130 (FIG. 1) can thus display first evaluee evaluation marker 4151 at evaluation grid 5100 as described above for FIG. 4, and can also concurrently display second evaluee evaluation marker 5152 at evaluation grid 5100, where second evaluee evaluation marker 5152 is similar to first evaluee evaluation marker 4151, but representative of second evaluee proficiency score 5212.

Display module 1130 (FIG. 1) is configured to present the evaluation data for the team members in a tabular format in the present example, as seen in team evaluation table 5300 (FIG. 5). Team evaluation table 5300 lists each of the team members of the user's team, and corresponding evaluation scores calculated by evaluation analyzer module 1120. For example, for team member “Evaluee-1,” team evaluation table 5300 presents evaluee combined performance score 4230, culture scores including evaluee combined leadership score 5241 and evaluee combined mission & behaviors score 5221, and evaluee proficiency score 4211, where: (a) evaluee combined performance score 4230 is derived from the different performance criteria scores in performance scores section 4400 of evaluee evaluation report 4000 (FIG. 4), (b) evaluee combined leadership score 5241 is derived from the different leadership traits criteria scores in culture scores section 4300 of evaluee evaluation report 4000 (FIG. 4), (c) evaluee combined mission & behaviors score 5221 is derived from the different behaviors and mission statement criteria scores in culture scores section 4300 of evaluee evaluation report 4000 (FIG. 4), and (d) evaluee proficiency score 4211 is derived, as described above with respect to FIG. 4, from the culture criteria scores in culture scores section 4300 and the performance criteria scores in performance scores section 4400 of evaluee evaluation report 4000 (FIG. 4). As another example, for team member “Evaluee-2,” team evaluation table 5300 presents evaluee combined performance score 5232, culture scores including evaluee combined leadership score 5242 and evaluee combined mission & behaviors score 5222, and evaluee proficiency score 5212. Evaluation scores for the rest of the team members may be derived and presented in team evaluation table 5300 in similar fashion to those of “Evaluee-1” as described above. Although the different culture scores for the team members are split between leadership scores column 5312 and mission & behaviors column 5311, there can be examples where evaluation table 5300 can present the different culture scores for the team members in a single culture column that merges together the scores in leadership scores column 5312 and mission & behaviors column 5311.

Evaluation analyzer module 1120 (FIG. 1) is also configured to calculate team proficiency score 5210 (FIG. 5), which is derived from the different proficiency scores of the team members in proficiency column 5315 of team evaluation table 5300. For instance, team proficiency score 5210 can be calculated from the different evaluee performance scores in performance column 5313 of team evaluation table 5300 (such as from evaluee combined performance scores 4230 and 5232), and from the different evaluee culture scores in culture columns 5311 and 5312 of team evaluation table 5300 (such as from evaluee combined mission & behaviors scores 5221 and 5222, and from evaluee combined leadership scores 5241 and 5242). Team proficiency score 5210 can thus based on the one or more evaluee culture scores of “Evaluee-1” (in culture scores section 4300 of evaluee evaluation report 4000 of FIG. 4), the one or more evaluee performance scores of “Evaluee-1” (in performance scores section 4400 of evaluee evaluation report 4000 of FIG. 4), the corresponding one or more evaluee culture scores the other evaluee(s) in the team (in the culture scores section of their respective evaluee evaluation report), and the corresponding one or more evaluee performance scores of the other evaluee(s) in the team (in the performance scores section of their respective evaluee evaluation report).

As seen in FIG. 5, display module 1130 (FIG. 2) can be configured to display team combined scores, such as team combined culture score 5220 and/or team combined performance score 5230, calculated by evaluation analyzer module 1120 (FIG. 5) from the different culture scores or performance scores of the team members. In some examples, team combined culture score 5220 can be based on the one or more evaluee culture scores of “Evaluee-1” (in culture scores section 4300 of evaluee evaluation report 4000 of FIG. 4) and the corresponding one or more evaluee culture scores the other evaluee(s) in the team (in the culture scores section of their respective evaluee evaluation report). In the same or other examples, team combined performance score 5230 can be based on the one or more evaluee performance scores of “Evaluee-1” (in performance scores section 4400 of evaluee evaluation report 4000 of FIG. 4), and the corresponding one or more evaluee performance scores of the other evaluee(s) in the team (in the performance scores section of their respective evaluee evaluation report).

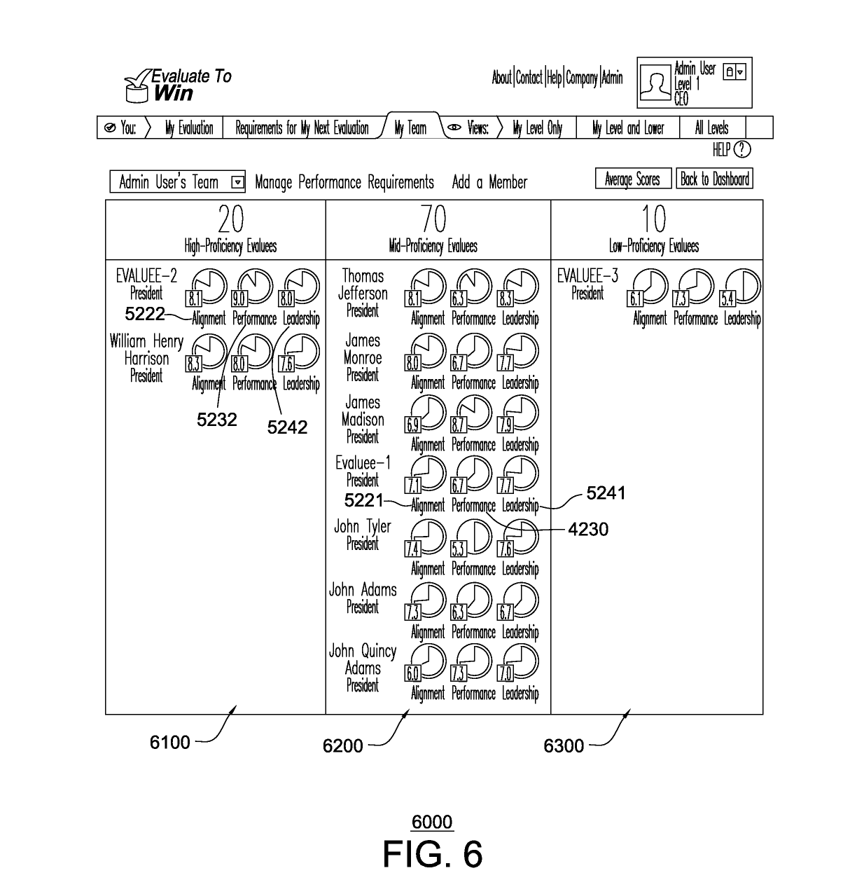

Returning to FIG. 2, method 2000 can also comprise, as sub-block 2530 of block 2500, displaying a team relative scoring report for the team of evaluees. FIG. 6 illustrates team relative scoring chart 6000, which can be similar to or comprise a portion of the team relative scoring report of sub-block 2530 of method 2000 (FIG. 2). In some examples, team relative scoring chart 6000 can be presented as a team relative scoring report panel by user interface module 1260 and/or user interface module 1160 (FIG. 1).

In FIG. 6, team relative scoring chart 6000 comprises entries for each of the team members of the team shown in FIG. 5, including “Evaluee-1” and “Evaluee-2.” Scoring data is presented for Evaluee-1, including an identifier for Evaluee-1, such as his/her name, and at least two of a combined performance score for Evaluee-1 (such as evaluee combined performance score 4230), a combined culture score for Evaluee-1 (such as evaluee combined leadership score 5241, evaluee combined mission & behavior score 5221, and/or a combination thereof), and/or a combined proficiency score for Evaluee-1 (such as evaluee proficiency score 4211 from FIGS. 4-5). Similarly, scoring data is presented for Evaluee-2, including an identifier for Evaluee-2, such as his/her name, and at least two of a combined performance score for Evaluee-2 (such as evaluee combined performance score 5232), a combined culture score for Evaluee-2 (such as evaluee combined leadership score 5242, evaluee combined mission & behavior score 5222, and/or a combination thereof), and/or a combined proficiency score for Evaluee-2 (such as evaluee proficiency score 5212 from FIG. 5). The scoring data for each of the evaluee team members can thus be presented side by side for ease of comparison. In the present example, the scoring data for the evaluees also comprises status icons and color-coded icons, as described above with respect to evaluation report 4000 (FIG. 4), providing a further visual aid for evaluating the proficiency of the different evaluees of the team.

In the present example of FIG. 6, relative scoring chart 6000 displays high-proficiency section 6100 for evaluees with a high-level evaluee proficiency score, mid-proficiency section 6200 for evaluees with a mid-level evaluee proficiency score, and low-proficiency section 6300 for evaluees with a low-level evaluee proficiency score. At least a portion of the scoring data for the different evaluees of the team is displayed in high-proficiency section 6100, mid-proficiency section 6200, or low-proficiency section 6300 depending on the respective evaluee proficiency score of each evaluee. As an example, high-proficiency section 6100 is reserved for evaluees who attain an evaluee proficiency score of 80% or more. Accordingly, the scoring data for Evaluee-2 whose evaluee proficiency score 5212 is of 8.2 (FIG. 5), is presented in high-proficiency section 6100. In the same or other examples, mid-proficiency section 6200 is reserved for evaluees who attain an evaluee proficiency score of between 70% and 80%. Accordingly, the scoring data for Evaluee-1 whose evaluee proficiency score 4211 is of 7.3 (FIG. 5), is presented in mid-proficiency section 6200. In the same or other examples, low-proficiency section 6300 is reserved for evaluees who attain an evaluee proficiency score of less than 70%. Accordingly, the scoring data for Evaluee-3 whose evaluee proficiency score 5213 is of 6.1 (FIG. 5), is presented in low-proficiency section 6300. There can be other examples with different proficiency score cutoffs between high-proficiency section 6100, mid-proficiency section 6200, and low-proficiency section 6300.

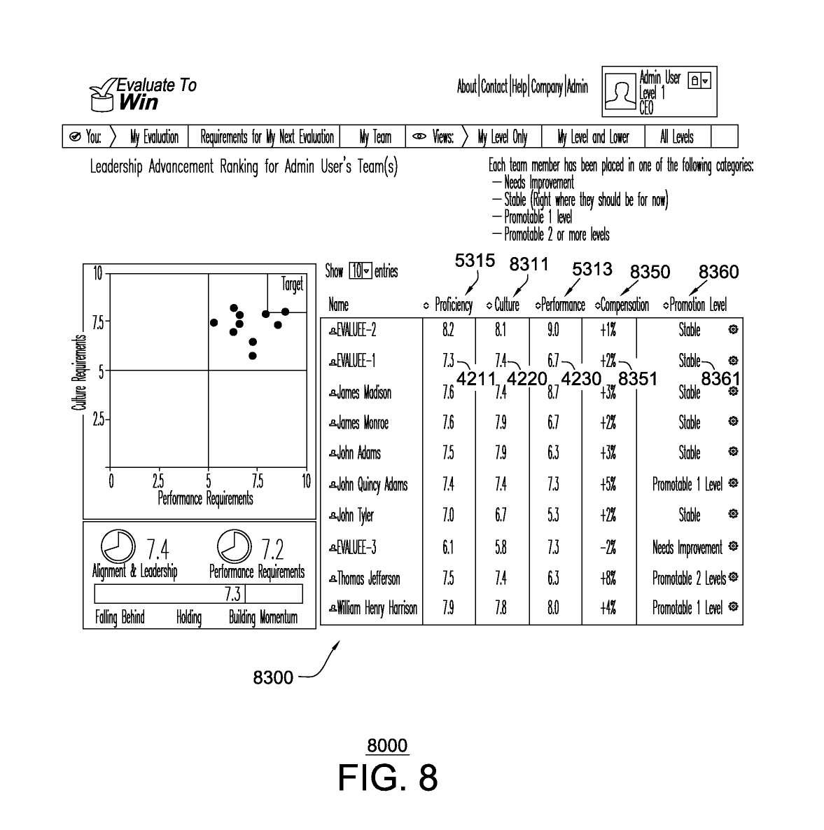

In some examples, evaluation analyzer module 1120 (FIG. 1) can be configured to generate recommended compensation and/or promotion adjustments for one or more of the team members. In the same or other examples, as seen in FIG. 8, display module 1130 (FIG. 1) can be configured to display recompense report 8000 for one or more of the team members of the team. In the example of FIG. 8, recompense report 8000 presents recompense chart 8300 comprising performance column 5313, culture column 8311, proficiency column 5315 with respective scores from the evaluations for each of the team members. In the same or other embodiments, culture column 8311 can be derived from the scores in mission & behavior column 5311 and from leadership column 5312 (FIG. 5).

Recompense report 8000 comprises compensation column 8350 presenting recommended compensation adjustments for each of the team members based on respective team member scores in proficiency column 5315, culture column 8311, and/or performance column 5313. For example, recommended compensation adjustment 8351 in compensation column 8350 can be generated by evaluation analyzer module 1120 (FIG. 1) based on evaluee proficiency score 4211 (FIGS. 4-5, 8), evaluee combined performance score 4230 (FIGS. 4-6, 8), and/or evaluee combined culture score 4220 (FIGS. 4, 8). In some examples, recommended compensation adjustment 8351 can correspond to a value or percentage change in salary amount, and/or a value or percentage change in bonus amount for Evaluee-1. Recompense report 8000 also comprises promotion column 8360 presenting recommended promotion levels for each of the team members based on respective team member scores in proficiency column 5315, culture column 8311, and/or performance column 5313. For example, recommended promotion level 8361 recommends that the promotion level for Evaluee-1 should remain “Stable” or unchanged. Other recommendations are possible. In some examples, the recommended adjustments in compensation column 8350 and/or promotion column 8360 can be automatically calculated by evaluation analyzer module 1120 (FIG. 1) based on the respective evaluation scores achieved by each of the team members. In other examples, the recommended adjustments in compensation column 8350 and/or promotion column 8360 may be input by a user such as an evaluator.

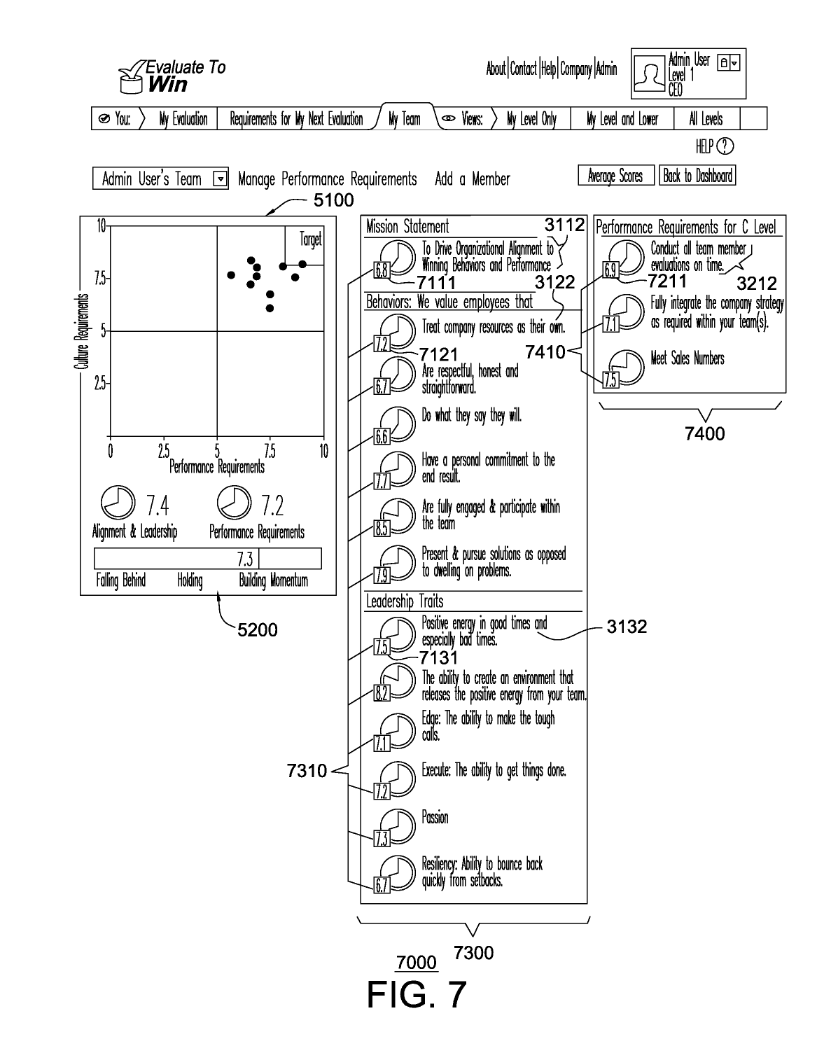

Returning to FIG. 2, method 2000 can also comprise, as sub-block 2540 of block 2500 for displaying a team average criteria scoring report for the team of evaluees. FIG. 7 illustrates team average criteria scoring chart 7000, which can be similar to or comprise a portion of the team average criteria scoring report of sub-block 2540 of method 2000 (FIG. 2). In some examples, team average criteria scoring chart 7000 can be presented as a team average criteria scoring report panel by user interface module 1260 and/or user interface module 1160 (FIG. 1).

In FIG. 7, team average criteria scoring report 7000 comprises team culture scores section 7300 and team performance scores section 7400, which can be respectively similar to culture scores section 4300 and to performance scores section 4400 of evaluee evaluation report 4000 (FIG. 4), but portraying information for the whole team rather than for only a single evaluee.

Evaluation analyzer module 1120 (FIG. 1) is configured to calculate, for each culture criteria of culture scores section 7300, one or more team culture criteria scores 7310 (such as mission statement team score 7111, behavior team score 7121, and leadership team score 7131) based on the evaluations of the different team members, such as based on the one or more first evaluee culture scores from the evaluation of Evaluee-1, and based on the one or more second evaluee culture scores from the evaluation of Evaluee-2. In some embodiments, for each culture criteria of culture scores section 7300, the corresponding evaluee culture scores of each of the team members may be averaged to derive the corresponding team culture criteria score. As an example, mission statement team score 7111 can be calculated for mission statement criteria 3112 based on the different scores of each of the team members with respect to mission statement criteria 3112 (such as Evaluee-1's mission statement score 3111 for mission statement criteria 3112 (FIG. 4), and Evaluee-2's corresponding mission statement score for mission statement criteria 3112). Similarly, behavior team score 7121 can be calculated for business values criteria 3122 based on the different scores of each of the team members with respect to business values criteria 3122. Similarly, leadership team score 7131 can be calculated for leadership criteria 3132 based on the different scores of each of the team members with respect to leadership criteria 3132.

In addition, evaluation analyzer module 1120 (FIG. 1) is configured to calculate, for each performance criteria of performance scores section 7400, one or more team performance criteria scores 7410 (such as performance team score 7211) based on the evaluations of the different team members, such as based on the one or more first evaluee performance scores from the evaluation of Evaluee-1, and based on the one or more second evaluee performance scores from the evaluation of Evaluee-2. In some embodiments, for each performance criteria of performance scores section 7400, the evaluee performance scores of each of the team members may be averaged to derive the corresponding team performance criteria score. As an example, performance team score 7211 can be calculated for performance criteria 3212 based on the different scores of each of the team members with respect to performance criteria 3212 (such as Evaluee-1's performance score 3211 for performance criteria 3212 (FIG. 4), and Evaluee-2's corresponding performance score for performance criteria 3212).

Once calculated by evaluation analyzer module 1120 (FIG. 1) as described above, the one or more team culture criteria scores 7310 and the one or more team performance criteria scores 7410 can be displayed by display module 1130 (FIG. 1) at team average criteria scoring chart 7000 (FIG. 7).

With respect to the description of method 2000 of FIG. 2 herein, in some examples, one or more of the different blocks of method 2000 can be combined into a single block or performed simultaneously, and/or the sequence of such blocks can be changed. For example, blocks 2200 and 2300 may be combined as a single block when the personnel culture alignment data and the personnel performance data is received substantially simultaneously at evaluation analyzer module 1120 from database module 1140 or 1440 (FIG. 1). In the same or other examples, some of the blocks of method 2000 can be subdivided into several sub-blocks. For example, block 2100 can be subdivided into a sub-block for receiving a portion of the evaluation data from an evaluee user, such as comments or other information to be used during the evaluation, and a sub-block for receiving a portion of the evaluation data from an evaluator user during the evaluation.

There can also be examples where method 2000 can comprise further or different blocks. As an example, method 2000 can further comprise a block for determining at least one of a compensation adjustment or a promotion level adjustment for the first evaluee based on at least one of the first evaluee evaluation report of sub-block 2510 and/or the team evaluation report of sub-block 2520. In some examples, the compensation adjustment or the promotion level adjustment may be calculated and/or recommended by evaluation analyzer module 1120 (FIG. 1) based on at least one of the evaluation scores of the first individual or of the evaluation scores of the team. In addition, there may be examples where method 2000 can comprise only part of the steps described above. For instance, one or more of sub-blocks 2510, 2520, 2530, and/or 2540 can be optional in some examples, and in the same or different examples, one or more of sub-blocks 2210, 2220, 2230, 2310, 2320, and 2330 can be optional. Other variations can be implemented for method 2000 without departing from the scope of the present disclosure.

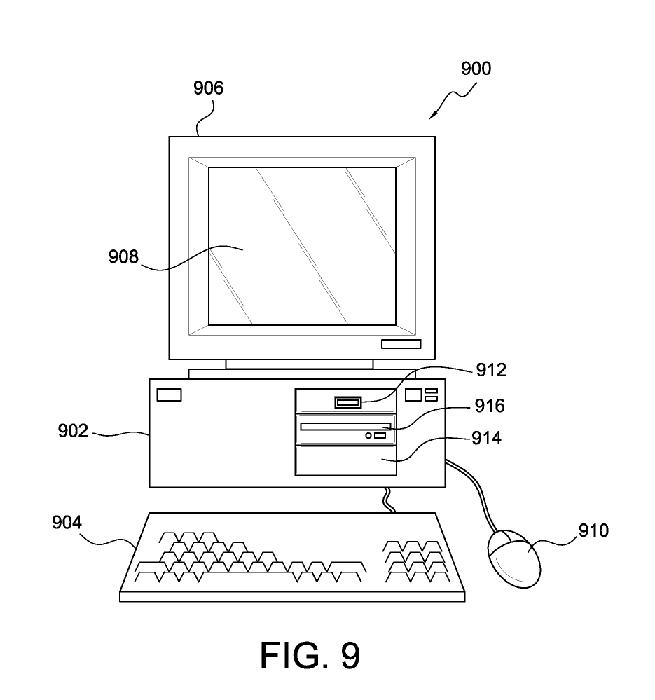

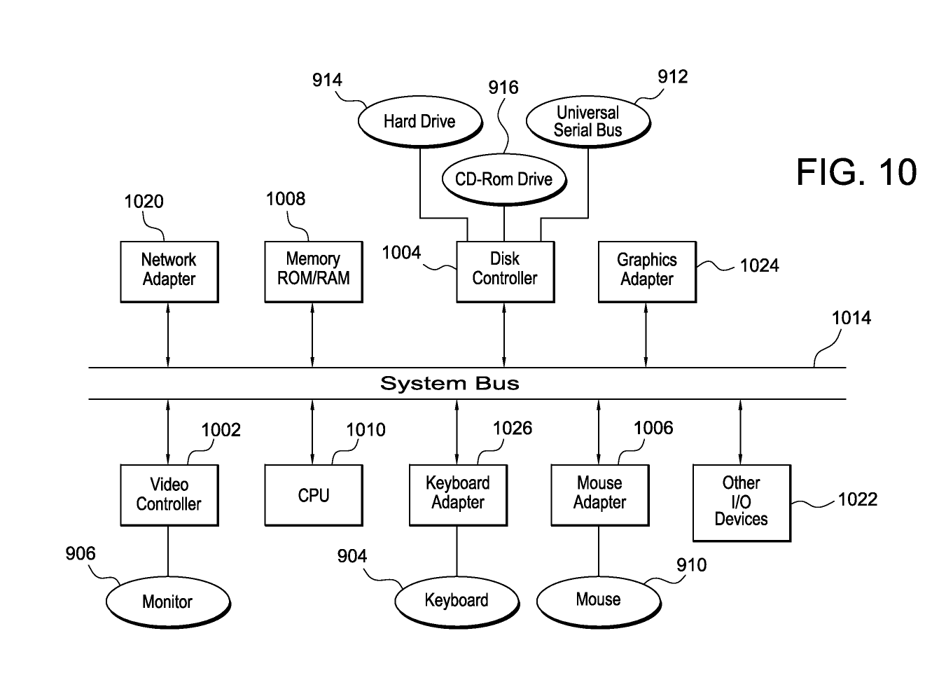

FIG. 9 illustrates a computer 900 that is suitable for implementing an embodiment of at least a portion of main system 1100 (FIG. 1) or client computer 1200 (FIG. 1). Computer 900 includes a chassis 902 containing one or more circuit boards (not shown), a USB (universal serial bus) port 912, a Compact Disc Read-Only Memory (CD-ROM) and/or Digital Video Disc (DVD) drive 916, and a hard drive 914. A representative block diagram of the elements included on the circuit boards inside chassis 902 is shown in FIG. 10. A central processing unit (CPU) 1010 in FIG. 10 is coupled to a system bus 1014 in FIG. 10. In various embodiments, the architecture of CPU 1010 can be compliant with any of a variety of commercially distributed architecture families.

System bus 1014 also is coupled to memory 1008 that includes both read only memory (ROM) and random access memory (RAM). Non-volatile portions of memory 1008 or the ROM can be encoded with a boot code sequence suitable for restoring computer 900 (FIG. 9) to a functional state after a system reset. In addition, memory 1008 can include microcode such as a Basic Input-Output System (BIOS). In some examples, database module 1140 (FIG. 1) can include memory 1008, USB port 912, hard drive 914, and/or CD-ROM or DVD drive 916.

In the depicted embodiment of FIG. 10, various I/O devices such as a disk controller 1004, a graphics adapter 1024, a video controller 1002, a keyboard adapter 1026, a mouse adapter 1006, a network adapter 1020, and other I/O devices 1022 can be coupled to system bus 1014. Keyboard adapter 1026 and mouse adapter 1006 are coupled to a keyboard 904 (FIGS. 9-10) and a mouse 910 (FIGS. 9-10), respectively, of computer 900 (FIG. 9). While graphics adapter 1024 and video controller 1002 are indicated as distinct units in FIG. 10, video controller 1002 can be integrated into graphics adapter 1024, or vice versa in other embodiments. Video controller 1002 is suitable for refreshing a monitor 906 (FIGS. 9-10) to display images on a screen 908 (FIG. 9) of computer 900 (FIG. 9). Disk controller 1004 can control hard drive 914 (FIGS. 9-10), USB port 912 (FIGS. 9-10), and/or CD-ROM or DVD drive 916 (FIGS. 9-10). In other embodiments, distinct units can be used to control each of these devices separately.

Network adapters 1020 can be coupled to one or more antennas. In some embodiments, network adapter 1020 can be part of a WNIC (wireless network interface controller) card (not shown) plugged or coupled to an expansion port (not shown) in computer 900. In other embodiments, the WNIC card can be a wireless network card built into internal computer 900. A wireless network adapter can be built into internal client computer 900 by having wireless Ethernet capabilities integrated into the motherboard chipset (not shown), or implemented via a dedicated wireless Ethernet chip (not shown), connected through the PCI (peripheral component interconnector) or a PCI express bus. In other embodiments, network adapter 1020 can be a wired network adapter.

Although many other components of computer 900 (FIG. 9) are not shown, such components and their interconnection are well known to those of ordinary skill in the art. Accordingly, further details concerning the construction and composition of computer 900 and the circuit boards inside chassis 902 (FIG. 9) need not be discussed herein.

When computer 900 in FIG. 9 is running, program instructions stored on a USB drive in USB port 912, on a CD-ROM or DVD in CD-ROM and/or DVD drive 916, on hard drive 914, or in memory 1008 (FIG. 10) are executed by CPU 1010 (FIG. 10). A portion of the program instructions, stored on these devices, can be suitable for carrying out method 2000 (FIG. 2) as described above.

Although the personnel management systems and related methods herein have been described with reference to specific embodiments, various changes may be made without departing from the spirit or scope of the present disclosure. For example, in some embodiments, evaluation analyzer module 1120 (FIG. 1) and display module 1130 (FIG. 1) may comprise a single module. Additional examples of such changes have been given in the foregoing description. Other permutations of the different embodiments having one or more of the features of the various figures are likewise contemplated. Accordingly, the specification and drawings herein are intended to be illustrative of the scope of the disclosure and are not intended to be limiting. It is intended that the scope of this application shall be limited only to the extent required by the appended claims.

The personnel management systems and related methods discussed herein may be implemented in a variety of embodiments, and the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

1. A personnel management system for evaluating one or more evaluees, the system comprising:
an evaluation analyzer module executable by one or more data processor devices and configured to:
receive personnel culture alignment data comprising:
one or more first evaluee culture scores of a first evaluee, correlated to one or more business culture criteria for the first evaluee;
receive personnel performance data comprising:
one or more first evaluee performance scores of the first evaluee, correlated to one or more performance criteria for the first evaluee; and
calculate a first evaluee proficiency score of the first evaluee based on:
the one or more first evaluee culture scores of the first evaluee; and
the one or more first evaluee performance scores of the first evaluee; and
a display module configured to display one or more personnel evaluation reports.

2. The personnel management system of claim 1, wherein:
the display module is configured to:
display an evaluation grid comprising:
a performance score axis; and
a culture score axis perpendicular to the performance score axis; and
display, at the evaluation grid, a first evaluee proficiency marker representative of the first evaluee proficiency score; and
at least a portion of the one or more personnel evaluation reports comprise the evaluation grid.

3. The personnel management system of claim 2, wherein:
the evaluation analyzer module is configured to:
calculate a first evaluee combined culture score based on the one or more first evaluee culture scores of the first evaluee; and
calculate a first evaluee combined performance score based on the one or more first evaluee performance scores of the first evaluee; and
the display module is configured to display at least one of:
the first evaluee combined culture score;
the first evaluee combined performance score; or
the first evaluee proficiency score.

4. The personnel management system of claim 3, wherein:
the performance score axis of the evaluation grid presents a performance score range configured to comprise the first evaluee combined performance score;
the culture score axis of the evaluation grid presents a culture score range configured to comprise the first evaluee combined culture score; and
the display module is configured to:
calculate the location of the first evaluee proficiency marker at an intersection between:
a first performance intersect line perpendicularly intersected to the performance score axis at the first evaluee combined performance score; and
a first culture intersect line perpendicularly intersected to the culture score axis at the first evaluee combined culture score.

5. The personnel management system of claim 2, wherein:
the display module is configured to display:
a target zone within the evaluation grid and representative of both:
a predetermined threshold culture score; and
a predetermined threshold performance score;
the target zone is highlighted with respect to other areas of the evaluation grid; and
the display module is configured to calculate the location of the first evaluee proficiency marker to be within the target zone when:
the first evaluee combined culture score equals or exceeds the predetermined threshold culture score; and
the first evaluee combined performance score equals or exceeds the predetermined threshold performance score.

6. The personnel management system of claim 2, wherein:
the one or more personnel evaluation reports comprise:
a first evaluee evaluation report of the first evaluee, comprising:
the evaluation grid;
the first evaluee proficiency marker in the evaluation grid; and
at least two of:
the first evaluee proficiency score;
a first evaluee combined culture score based on the one or more first evaluee culture scores;
a first evaluee combined performance score based on the one or more first evaluee performance scores;
a portion of the one or more first evaluee culture scores; or
a portion of the one or more first evaluee performance scores.

7. The personnel management system of claim 2, wherein:
the personnel culture alignment data received by the evaluation analyzer module comprises:
one or more prior evaluee culture scores from a prior evaluation of the first evaluee;
the personnel performance data received by the evaluation analyzer module comprises:
one or more prior evaluee performance scores from the prior evaluation of the first evaluee;
the evaluation analyzer module is configured to:
calculate a prior evaluee proficiency score for the prior evaluation of the first evaluee based on:
the one or more prior evaluee culture scores of the first evaluee; and
the one or more prior evaluee performance scores of the first evaluee;
the display module is configured to:
display, at the evaluation grid, a prior evaluee proficiency marker representative of the prior evaluee proficiency score.

8. The personnel management system of claim 7, wherein:
the display module is configured to concurrently display, at the evaluation grid:
the first evaluee proficiency marker of the first evaluee; and
the prior evaluee proficiency marker of the first evaluee

9. The personnel management system of claim 2, wherein:
the personnel culture alignment data received by the evaluation analyzer module comprises:
one or more second evaluee culture scores of a second evaluee;
the personnel performance data received by the evaluation analyzer module comprises:
one or more second evaluee performance scores of the second evaluee;
the evaluation analyzer module is configured to:
calculate a second evaluee proficiency score of the second evaluee based on:
the one or more second evaluee culture scores of the second evaluee; and
the one or more second evaluee performance scores of the second evaluee;
the display module is configured to:
concurrently display, at the evaluation grid:
the first evaluee proficiency marker of the first evaluee; and
a second evaluee proficiency marker representative of the second evaluee proficiency score of the second evaluee.

10. The personnel management system of claim 9, wherein:
the evaluation analyzer module is configured to:
calculate a team proficiency score based on:
the one or more first evaluee culture scores of the first evaluee;
the one or more first evaluee performance scores of the first evaluee;
the one or more second evaluee culture scores of the second evaluee; and
the one or more second evaluee performance scores of the second evaluee.

11. The personnel management system of claim 10, wherein:
the evaluation analyzer module is configured to:
calculate a team combined culture score based on:
the one or more first evaluee culture scores of the first evaluee; and
the one or more second evaluee culture scores of the second evaluee; and
calculate a team combined performance score based on:
the one or more first evaluee performance scores of the first evaluee; and
the one or more second evaluee performance scores of the second evaluee; and
the display module is configured to display at least one of:
the team combined culture score;
the team combined performance score; or
the team proficiency score.

12. The personnel management system of claim 9, wherein:
the evaluation analyzer module is configured to:
calculate a first evaluee combined culture score based on the one or more first evaluee culture scores of the first evaluee;
calculate a first evaluee combined performance score based on the one or more first evaluee performance scores of the first evaluee;
calculate a second evaluee combined culture score based on the one or more second evaluee culture scores of the second evaluee; and
calculate a second evaluee combined performance score based on the one or more second evaluee performance scores of the second evaluee;
the display module is configured to:
display a team relative scoring chart comprising:
first evaluee scoring data comprising:
an identifier for the first evaluee; and
at least two of:
the first evaluee combined culture score;
the first evaluee combined performance score; or
the first evaluee proficiency score; and
second evaluee scoring data comprising:
an identifier for the second evaluee; and
at least two of:
the second evaluee combined culture score;
the second evaluee combined performance score; or
the second evaluee proficiency score.

13. The personnel management system of claim 12, wherein:
the display module is configured to:
display, at the team relative scoring chart:
a high-proficiency section for evaluees with a high-level evaluee proficiency score;
a mid-proficiency section for evaluees with a mid-level evaluee proficiency score; and
a low-proficiency section for evaluees with a low-level evaluee proficiency score;
display at least a portion of the first evaluee scoring data of the first evaluee in one of the high-proficiency section, the mid-proficiency section, or the low-proficiency section of the team relative scoring chart based on the first evaluee proficiency score; and
display at least a portion of the second evaluee scoring data of the second evaluee in one of the high-proficiency section, the mid-proficiency section, or the low-proficiency section of the team relative scoring chart based on the second evaluee proficiency score.

14. The personnel management system of claim 13, wherein:
the evaluation analyzer module is configured to:
calculate one or more team culture scores based on an average between corresponding ones of:
the one or more first evaluee culture scores; and
the one or more second evaluee culture scores; and
calculate one or more team performance scores based on an average between corresponding ones of:
the one or more first evaluee performance scores; and
the one or more second evaluee performance scores; and
the display module is configured to:
display a team average scoring chart comprising:
the one or more team culture scores; and
the one or more team performance scores.

15. The personnel management system of claim 1, wherein:
the one or more first evaluee culture scores comprise at least two of:
a mission statement score reflective of an assessment of the evaluee with respect to a business mission statement criteria;
one or more behavior scores reflective of an assessment of the evaluee with respect to one or more business values criteria; or
one or more leadership scores reflective of an assessment of the evaluee with respect to one or more leadership criteria; and
the one or more business culture criteria comprise at least two of the business mission statement criteria, the one or more business values criteria, or the one or more leadership criteria.

16. The personnel management system of claim 1, wherein:
the display module is configured to display:
a first evaluee evaluation report of the first evaluee;
the first evaluee evaluation report comprises:
a first evaluee proficiency momentum indicator comprising:
a decreasing proficiency momentum classification;
a stable proficiency momentum classification; and
an increasing proficiency momentum classification; and
a correlation of the first evaluee proficiency score with one of:
the decreasing proficiency momentum classification;
the stable proficiency momentum classification; or
the increasing proficiency momentum classification.

17. The personnel management system of claim 1, wherein:
the one or more personnel evaluation reports comprise:
a first evaluee evaluation report of the first evaluee; and
the first evaluee evaluation report comprises at least one of:
one or more culture status icons correlated to the one or more first evaluee culture scores; or
one or more performance status icons correlated to the one or more first evaluee performance scores.

18. The personnel management system of claim 17, wherein:
at least one of the one or more culture status icons or the one or more performance status icons comprises:
one or more pie chart icons representative of a score percentage for their correlated one or more first evaluee culture scores or for their correlated one or more first evaluee performance scores.

19. The personnel management system of claim 1, further comprising:
a communications module coupled to a database and configured to:
send to the database the personnel culture alignment data and the personnel performance data; and
send to the evaluation analyzer module the personnel culture alignment data and the personnel performance data.

20. The personnel management system of claim 19, wherein:
the communications module is configured to:
couple with a user interface module via a cloud computer network;
the user interface module is configured to:
receive the personnel culture alignment data and the personnel performance data from at least one of an evaluator or the first evaluee;
send the personnel culture alignment data and the personnel performance data to the communications module via the cloud computer network;
receive the one or more evaluation reports displayed by the display module via the cloud computer network; and
present the one or more evaluation reports to one or more users.

21. The personnel management system of claim 1, wherein:
when the personnel management system is provided by an evaluation system provider to an evaluation system client:
at least a portion of the one or more business culture criteria or of the one or more performance criteria is developed for the evaluation system client by the evaluation system provider based on one or more business culture goals and personnel performance goals of the evaluation system client.

22. The personnel management system of claim 1, wherein:
the evaluation analyzer module is configured to:
calculate at least one of a recommended compensation adjustment or a recommended promotion level adjustment for the first evaluee based on:
the one or more first evaluee culture scores of the first evaluee; and
the one or more first evaluee performance scores of the first evaluee.

23. The personnel management system of claim 1, wherein:
the display module is configured to:
display a first evaluation interface for a first evaluee evaluation of the first evaluee; and
the first evaluation interface comprises at least two of:
a culture score interface configured to receive a score for each of the one or more first evaluee culture scores of the first evaluee for the first evaluee evaluation;
a performance score interface configured to receive a score for each of the one or more first evaluee performance scores of the first evaluee for the first evaluee evaluation;
an importation interface configured to import to the first evaluation interface one or more prior scores or prior comments from a prior evaluee evaluation of the first evaluee; or
an evaluee notes interface configured to present one or more evaluee notes received from the first evaluee regarding its proficiency with respect to at least a portion of:
the one or more business culture criteria for the first evaluee; or
the one or more performance criteria for the first evaluee.

24. The personnel management system of claim 23, wherein:
the first evaluation interface comprises:
a criteria modification interface configured to add to the first evaluation interface at least one of:
a new business culture criteria of the one or more business culture criteria for the first evaluee; or
a new performance criteria of the one or more performance criteria for the first evaluee.

25. The personnel management system of claim 1, wherein:
the evaluation analyzer module and the display module comprise a single module.

26. A method for evaluating one or more evaluees, the method comprising:
providing an evaluation analyzer module configured to:
receive personnel culture alignment data comprising:
one or more first evaluee culture scores of a first evaluee, correlated to one or more business culture criteria for the first evaluee;
receive personnel performance data comprising:
one or more first evaluee performance scores of the first evaluee, correlated to one or more performance criteria for the first evaluee; and
calculate a first evaluee proficiency score of the first evaluee based on:
the one or more first evaluee culture scores of the first evaluee; and
the one or more first evaluee performance scores of the first evaluee; and
providing a display module configured to display one or more personnel evaluation reports;
wherein at least the evaluation analyzer module is executable by one or more data processor devices.

27. The method of claim 26, wherein:
providing the display module comprises:
configuring the display module to:
display an evaluation grid in at least a portion of the one or more personnel evaluation reports, the evaluation grid comprising:
a performance score axis; and
a culture score axis perpendicular to the performance score axis; and
display the first evaluee proficiency marker at the location in the evaluation grid relative to the performance score axis and the culture score axis.

28. The method of claim 27, wherein:
providing the evaluation analyzer module further comprises:
providing the evaluation analyzer module to:
calculate a first evaluee combined culture score based on the one or more first evaluee culture scores of the first evaluee; and
calculate a first evaluee combined performance score based on the one or more first evaluee performance scores of the first evaluee; and
providing the display module further comprises
providing the display module to:
display at least one of:
the first evaluee combined culture score;
the first evaluee combined performance score; or
the first evaluee proficiency score; and
calculate the location of the first evaluee proficiency marker at an intersection between:
a first performance intersect line perpendicularly intersected to the performance score axis at the first evaluee combined performance score; and
a first culture intersect line perpendicularly intersected to the culture score axis at the first evaluee combined culture score.

29. The method of claim 27, wherein:
providing the evaluation analyzer module further comprises:
providing the evaluation analyzer module to:
receive one or more second evaluee culture scores of a second evaluee as part of the personnel culture alignment data;
receive one or more second evaluee performance scores of the second evaluee as part of the personnel performance data; and
calculate a second evaluee proficiency score of the second evaluee based on:
the one or more second evaluee culture scores of the second evaluee; and
the one or more second evaluee performance scores of the second evaluee; and
providing the display module further comprises:
providing the display module to:
display a target zone within the evaluation grid and representative of both:
a predetermined threshold culture score; and
a predetermined threshold performance score;
calculate the location of the first evaluee proficiency marker to be within the target zone when:
the first evaluee combined culture score equals or exceeds the predetermined threshold culture score; and
the first evaluee combined performance score equals or exceeds the predetermined threshold performance score; and
concurrently display, at the evaluation grid:
the first evaluee proficiency marker of the first evaluee; and
a second evaluee proficiency marker representative of the second evaluee proficiency score of the second evaluee;
wherein:
the target zone is highlighted with respect to other areas of the evaluation grid; and
the one or more first evaluee culture scores comprise at least two of:
a mission statement score reflective of an assessment of the evaluee with respect to a business mission statement criteria;
one or more behavior scores reflective of an assessment of the evaluee with respect to one or more business values criteria; or
one or more leadership scores reflective of an assessment of the evaluee with respect to one or more leadership criteria; and
the one or more business culture criteria comprise at least two of the business mission statement criteria, the one or more business values criteria, or the one or more leadership criteria.

30. An evaluation interface module operable on one or more processors, storable in one or more memory units, displayable at a client computer, and configured to couple to a personnel management system comprising an evaluation analyzer module,
the evaluation interface module comprising:
an evaluation interface panel; and
a first evaluee evaluation report panel;
wherein:
the evaluation interface panel is configured to:
receive personnel culture alignment data comprising:
one or more first evaluee culture scores of a first evaluee, correlated to one or more business culture criteria for the first evaluee; and
receive personnel performance data comprising:
one or more first evaluee performance scores of the first evaluee, correlated to one or more performance criteria for the first evaluee; and
the first evaluee evaluation report panel is configured to:
present a first evaluee proficiency score of the first evaluee,
the first evaluee proficiency score received from the personnel management system and calculated by the evaluation analyzer module based on the one or more first evaluee culture scores and the one or more first evaluee performance scores; and
present an evaluation grid comprising:
a performance score axis;
a culture score axis perpendicular to the performance score axis; and
a first evaluee proficiency marker representative of the first evaluee proficiency score relative to the performance score axis and the culture score axis.

31. The evaluation interface module of claim 30, wherein:
the first evaluee evaluation report panel is configured to present at least one of:
a first evaluee combined culture score calculated by the evaluation analyzer module and based on the one or more first evaluee culture scores of the first evaluee; and
a first evaluee combined performance score calculated by the evaluation analyzer module based on the one or more first evaluee performance scores of the first evaluee;
a performance score range configured to comprise the first evaluee combined performance score with respect to the performance score axis of the evaluation grid;
a culture score range configured to comprise the first evaluee combined culture score with respect to the culture score axis of the evaluation grid; or
the first evaluee proficiency marker at an intersection between:
a first performance intersect line perpendicularly intersected to the performance score axis at the first evaluee combined performance score; and
a first culture intersect line perpendicularly intersected to the culture score axis at the first evaluee combined culture score.

32. The evaluation interface module of claim 30, further comprising:
a team evaluation report panel;
wherein:
the personnel culture alignment data received by the evaluation interface panel comprises:
one or more second evaluee culture scores of a second evaluee;
the personnel performance data received by the evaluation interface panel comprises:
one or more second evaluee performance scores of the second evaluee; and
the team evaluation report panel is configured to:
present the evaluation grid comprising:
the performance score axis;
the culture score axis perpendicular to the performance score axis;
the first evaluee proficiency marker representative of the first evaluee proficiency score relative to the performance score axis and the culture score axis; and
a second evaluee proficiency marker representative of a second evaluee proficiency score of the second evaluee relative to the performance score axis and the culture score axis, the second evaluee proficiency score received from the personnel management system and calculated by the evaluation analyzer module based on the one or more second evaluee culture scores and the one or more second evaluee performance scores; and
present a team proficiency score calculated by the evaluation analyzer module based on:
the one or more first evaluee culture scores of the first evaluee;
the one or more first evaluee performance scores of the first evaluee;
the one or more second evaluee culture scores of the second evaluee; and
the one or more second evaluee performance scores of the second evaluee.

33. The evaluation interface module of claim 30, further comprising:
a team relative scoring report panel comprising:
a high-proficiency section for evaluees with a high-level evaluee proficiency score;
a mid-proficiency section for evaluees with a mid-level evaluee proficiency score; and
a low-proficiency section for evaluees with a low-level evaluee proficiency score;
first evaluee scoring data comprising:
an identifier for the first evaluee; and
the first evaluee proficiency score;
second evaluee scoring data comprising:
an identifier for the second evaluee; and
the second evaluee proficiency score; and
wherein the team relative scoring report panel is configured to:
present at least a portion of the first evaluee scoring data in one of the high-proficiency section, the mid-proficiency section, or the low-proficiency section based on the first evaluee proficiency score; and
present at least a portion of the second evaluee scoring data in one of the high-proficiency section, the mid-proficiency section, or the low-proficiency section based on the second evaluee proficiency score.

34. The evaluation interface module of claim 30, further comprising:
a team average criteria scoring report panel comprising:
one or more team culture scores; and
one or more team performance scores;
wherein:
the personnel culture alignment data received by the evaluation interface panel comprises:
one or more second evaluee culture scores of a second evaluee;
the personnel performance data received by the evaluation interface panel comprises:
one or more second evaluee performance scores of the second evaluee;
the one or more team culture scores are calculated by the evaluation analyzer module based on an average between corresponding ones of:
the one or more first evaluee culture scores; and
the one or more second evaluee culture scores; and
the one or more team performance scores are calculated by the evaluation analyzer module based on an average between corresponding ones of:
the one or more first evaluee performance scores; and
the one or more second evaluee performance scores.
